(19) United States
(12) Patent Application Publication
(10) Pub. No.: US 2026/0171505 A1
(43) Pub. Date: Jun. 18, 2026

(54) METHOD FOR MANUFACTURING BATTERY CELL

(71) Applicant: MAZDA MOTOR CORPORATION, Hiroshima (JP)

(72) Inventors: Yoshimura TAIKI, Hiroshima (JP); Kuwako SHUN, Hiroshima (JP); Kajimoto TAKANORI, Hiroshima (JP); Shimizu SHINICHI, Hiroshima (JP); Ito KOSAKU, Hiroshima (JP)

(73) Assignee: MAZDA MOTOR CORPORATION, Hiroshima (JP)

(21) Appl. No.: 19/411,681

(22) Filed: Dec. 8, 2025

(30) Foreign Application Priority Data
Dec. 18, 2024 (JP) 2024-222353

(51) Int. Cl. H01M 10/0585; H01M 10/04; H01M 10/0525; H01M 50/105

(52) U.S. Cl. CPC H01M 10/0585; H01M 10/049; H01M 10/0525; H01M 50/105

(57) ABSTRACT

To prevent an electricity generation element from being affected by heat during manufacture of a battery cell, a method for manufacturing a battery cell includes: stacking electrode sheets in a layering direction to form an electricity generation element, the electrode sheets each including an electrode and a current collector, the electrodes being located in a container, the current collectors each being connected to the electrode in the container and protruding outward from an opening of the container; pressurizing and heating resin pieces from an outside toward a center in layering direction at positions of the openings of the container, the resin pieces being located between the adjacently stacked current collectors; promoting transfer of heat from the electricity generation element to an outside of the electricity generation element during pressurizing and heating the resin pieces; welding resin pieces together between the current collectors; and sealing the opening of the container.

### TECHNICAL FIELD

A technique disclosed herein relates to a method for manufacturing a battery cell.

### BACKGROUND

Japanese Patent Laid-Open No. 2009-272161 describes a conventional laminated battery. The laminated battery is a battery in which an electrode body is housed in an exterior member. The laminated battery includes a plurality of current-collecting terminals that are pulled out from the electrode body to the outside of the exterior member. The plurality of current-collecting terminals are stacked with thermoplastic resin pieces interposed therebetween. At the periphery of the exterior member, the resin pieces are welded to each other and to the exterior member, thereby closing the periphery of the exterior member from which the current-collecting terminals are drawn out.

In the laminated battery, each of the plurality of current-collecting terminals is pulled out to the outside of the exterior member. The plurality of current-collecting terminals are not connected to each other in the exterior member. In the laminated battery, the space in the exterior member can be used to expand the electrode body. The structure of the laminated battery is advantageous for improving the energy density of the battery.

### SUMMARY

The laminated battery is manufactured by a heat sealing process. In the heat sealing process, the stacked resin pieces at the periphery of the exterior member are welded together by being pressed by the hot plate, which is an energy supply source, in the stacking direction.

In the laminated battery, the electrode body expands in the exterior member as described above. The electrode body is located near the periphery of the exterior member. In the heat sealing process, when the resin pieces are heated by the hot plate, the temperature of the electrode body near the hot plate may increase excessively. If the temperature of the electrode body becomes too high, the separator of the electrode body may undergo heat shrink, causing a short-circuit of the electrodes in the laminated battery after manufacture.

The technique disclosed herein prevents an electricity generation element from being affected by heat during manufacturing a battery cell.

The technique disclosed herein relates to a method for manufacturing a battery cell. This manufacturing method includes:
stacking electrode sheets in a layering direction to form an electricity generation element, the electrode sheets each including an electrode and a current collector, the electrodes being located in a container, the current collectors each being connected to the electrode in the container and protruding outward from an opening of the container;
pressurizing and heating resin pieces from an outside toward a center in the layering direction at a position of the opening of the container, the resin pieces being located between the adjacently stacked current collectors;
promoting transfer of heat from the electricity generation element to an outside of the electricity generation element during pressurizing and heating the resin pieces; and
welding the resin pieces together between the current collectors, and sealing the opening of the container.

In the battery cell manufactured by this manufacturing method, each of the plurality of stacked current collectors protrudes outside the container through the opening of the container. The plurality of current collectors are connected to electrodes with the same polarity, for example. Inside the container, the plurality of current collectors are not connected to each other. The connection space between the current collectors inside the container can be omitted. The electricity generation element including the electrodes can be expanded by using the space inside the container. The battery cell of this structure can have a high energy density.

The opening of the container is sealed with resin pieces. The resin pieces are, for example, a thermoplastic resin pieces. During manufacturing the battery cell, the resin pieces between the stacked current collectors at the opening position of the container are pressurized and heated from the outside toward the center in the layering direction. For example, a pair of hot plates positioned on the outside of the container may be used with a plurality of resin pieces interposed therebetween in the layering direction, and at the same time, the hot plates may supply heat energy to the resin pieces from the outside toward the center in the layering direction, thereby pressurizing and heating the resin pieces. The resin pieces are welded together between the current collectors to seal the opening of the container.

The electricity generation element here expands close to the opening of the container. While the resin pieces sealing the opening are pressurized and heated, the electricity generation element may also be heated, causing an excessive increase in temperature.

In the manufacturing method described above, while the resin pieces are pressurized and heated, transfer of heat from the electricity generation element to the outside of the electricity generation element is promoted. The temperature rise of the electricity generation element is prevented. The electricity generation element is less susceptible to the effects of heat during manufacturing a battery cell. The occurrence of defects in the battery cell after manufacture is prevented.

Each of the electrode sheets may further includes a separator, the separator being in contact with the electrode on a side opposite the current collector, the separator separating the electrodes in the layering direction between the stacked electrode sheets.

When the separator is heated, it may undergo heat shrink. As described above, while the resin pieces are pressurized and heated, the temperature rise of the electricity generation element is prevented, and heat shrink of the separator is prevented. The occurrence of a short-circuit of the electrodes can be prevented in the manufactured battery cell.

It is also possible that:
the stacked resin pieces may be interposed between a pair of hot plates in the layering direction, and thereby the resin pieces are pressurized and heated, the hot plates being positioned outside the container; and
while the resin pieces are pressurized and heated, a heat sink is brought into contact with an outer surface of the container at a position corresponding to the electrodes of the electricity generation element, and thereby promotes transfer of heat from the electricity generation element to the heat sink.

When the resin pieces are pressurized and heated using a hot plate, heat from the hot plate is also likely to be transferred to the electricity generation element located near the resin pieces.

In contrast, the heat sink is in contact with the outer surface of the container at a position corresponding to the electrodes of the electricity generation element, thereby promoting transfer of heat from the electricity generation element to the heat sink. As a result, the temperature rise of the electricity generation element is prevented. The position corresponding to the electrodes of the electricity generation element is also the position corresponding to the separator of the electricity generation element. Heat shrink of the separator is prevented.

The heat sink may be brought into contact with an outer surface of the container before the resin pieces are pressurized and heated.

If the heat sink is in contact with the outer surface of the container in advance, transfer of heat from the electricity generation element to the heat sink starts quickly after pressurization and heating of the resin pieces is started. The temperature rise of the electricity generation element is effectively prevented.

The heat sink may be cooled by a cooling device.

If the heat sink is cooled, the transfer of heat from the electricity generation element to the heat sink is further promoted. The temperature rise of the electricity generation element is further prevented.

Before pressurization and heating of the resin pieces is started, preheating of the resin pieces through the current collectors may be started.

When a pair of hot plates positioned on the outside of the container is used with the plurality of resin pieces interposed therebetween in the layering direction and heat energy is supplied to the resin pieces from the outside toward the center in the layering direction, the heat energy is transferred in order from the resin pieces on the outside to the resin pieces in the center in the layering direction. The heat energy supplied to the resin pieces located in the center in the layering direction is likely to be lower than the heat energy supplied to the resin pieces located on the outside in the layering direction due to attenuation.

In the disclosed manufacturing method, the resin pieces are preheated through the current collectors before start of pressurization and heating of the resin pieces. Heat energy is efficiently supplied to the resin pieces located in the center in the layering direction through the current collectors located in the center in the layering direction.

Preheating of the resin pieces through the current collectors is combined with pressurization and heating from the outside in the layering direction, so that heat energy is sufficiently supplied to both the resin pieces located on the outside in the layering direction and the resin pieces located in the center in the layering direction. As a result, all the resin pieces are welded together throughout the entire layering direction during manufacturing the battery cell. The sealing strength of the opening of the container is prevented from varying from part to part.

Preheating through the current collectors improves the sealing quality of the opening of the container while heat is transferred also to the electricity generation element through the current collectors if the current collectors are heated. The temperature of the electrodes or separators is likely to be high. In contrast, in the manufacturing method described above, the transfer of heat from the electricity generation element to the outside of the electricity generation element is promoted, thereby effectively preventing the temperature rise of the electricity generation element.

Preheating through the current collectors may be continued also after start of pressurization and heating of the resin pieces.

If preheating through the current collectors is ended during pressurization and heating of the resin pieces, the temperature of the resin pieces may drop due to heat dissipation through the current collectors. When preheating through the current collectors is continued also after start of pressurization and heating of the resin pieces, heat dissipation through the current collectors is prevented. All the resin pieces are welded together, and the opening of the container is stably sealed.

After pressurization and heating of the resin pieces is completed, promotion of transfer of heat from the electricity generation element to the outside of the electricity generation element may be continued.

The temperature of the electricity generation element is relatively high even after pressurization and heating of the resin pieces is completed. If the transfer of heat from the electricity generation element to the outside of the electricity generation element is continued to be promoted, the temperature of the electricity generation element drops quickly. The electricity generation element is prevented from being affected by heat during manufacturing a battery cell.

The manufacturing method of the battery cell described above can prevent the electricity generation element from being affected by heat during manufacturing the battery cell.

### BRIEF DESCRIPTION OF THE DRAWINGS

FIG. 1 is a cross-sectional view of a battery cell.

FIG. 2 shows a part of a manufacturing procedure of a battery cell.

FIG. 3 shows a part of the manufacturing procedure of the battery cell.

FIG. 4 shows a part of the manufacturing procedure of the battery cell.

FIG. 5 shows a part of the manufacturing procedure of the battery cell.

FIG. 6 shows a part of the manufacturing procedure of the battery cell.

### DETAILED DESCRIPTION

Hereinafter, an embodiment of a manufacturing procedure of a battery cell will be described with reference to the drawings. The battery cell manufacturing procedure described here is an example.

### Battery Cell Structure

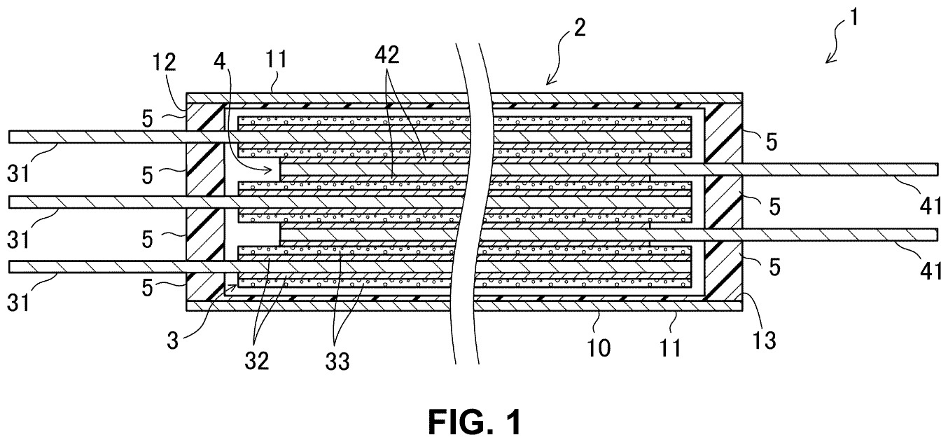

FIG. 1 schematically shows an overall structure of a battery cell 1. The battery cell 1 is a secondary battery. The battery cell 1 is, for example, a lithium ion battery.

The battery cell 1 is a so-called pouch-type battery. The battery cell 1 includes an electricity generation element 2 and a container 10. The container 10 is sealed with the electricity generation element 2 and the electrolyte contained therein. The container 10 is formed into a bag shape by folding one laminate material 11 or by stacking two laminate materials 11. The laminate material 11 has a three-layer structure in which a metal layer is interposed between two resin layers. The metal layer is, for example, aluminum or stainless steel. The resin layer is made of, for example, polypropylene (PP) or polyethylene (PE).

The electricity generation element 2 has first electrode sheets 3. The first electrode sheets 3 are, for example, negative electrode sheets. The electricity generation element 2 has second electrode sheets 4. The second electrode sheets 4 are, for example, positive electrode sheets. The first electrode sheets 3 and the second electrode sheets 4 are alternately stacked. The numbers of the first electrode sheets 3 and the second electrode sheets 4 are optional in the electricity generation element 2. The electricity generation element 2 is an electrode-layered product. In the following, the direction in which the first electrode sheets 3 and the second electrode sheets 4 are layered may be referred to as the layering direction. The layering direction is the up-down direction on the paper surface of FIG. 1 and FIGS. 2 to 6 described later.

Each first electrode sheet 3 has a current collector 31. The current collector 31 is a thin plate or foil that extends in a direction perpendicular to the layering direction. An end of the current collector 31, that is, the left end in FIG. 1, protrudes outside the container 10 from the first opening 12 of the container 10.

A first surface and a second surface of each current collector 31 located inside the container 10 are coated with an active material. The first surface is the upper surface of the current collector 31 in FIG. 1, and the second surface is the lower surface of the current collector 31 in FIG. 1. The active material forms first electrodes 32. The current collector 31 is connected to the first electrodes 32 inside the container 10.

Each first electrode sheet 3 has separators 33. Each separator 33 separates the first electrode 32 of the first electrode sheet 3 from a second electrode 42 of the second electrode sheet 4, which will be described later. The separator 33 is, for example, a porous material through which ionic substances can pass.

Each separator 33 covers the surface of a corresponding one of the two first electrodes 32 in the first electrode sheet 3. The separator 33 may be formed by pasting a film forming the separator 33 to the first electrode 32. The separator 33 may also be formed by drying the slurry applied to the first electrode 32. The area of the separator 33 may be the same as or larger than the area of the first electrode sheet 3.

Each second electrode sheet 4 has a current collector 41. The current collector 41 is a thin plate or foil that extends in a direction perpendicular to the layering direction. An end of the current collector 41, that is, the right end in FIG. 1, protrudes outside the container 10 from the second opening 13 of the container 10. The second opening 13 is an opening opposite to the first opening 12 in the direction perpendicular to the layering direction. The protruding direction of the current collector 41 is not limited to the opposite direction to the protruding direction of the current collector 31.

A first surface and a second surface of each current collector 41 located inside the container 10 are coated with an active material. The active material forms second electrodes 42. The current collector 41 is connected to the second electrodes 42 inside the container 10.

As described above, the first electrode sheets 3 and the second electrode sheets 4 are alternately layered. The first electrodes 32 and the second electrodes 42 are stacked in the layering direction inside the container 10 via the separators 33.

The first opening 12 of the container 10 is sealed with resin pieces 5. Each resin piece 5 is a sealing material. The resin pieces 5 are located between the laminate material 11 and the current collectors 31, and between the current collectors 31. Similarly, the second opening 13 is sealed with resin pieces 5. The resin pieces 5 are located between the laminate material 11 and the current collectors 41, and between the current collectors 41.

The plurality of current collectors 31 are not connected to each other inside the container 10 and protrude individually outside the container 10. Similarly, the plurality of current collectors 41 are not connected to each other inside the container 10 and protrude individually outside the container 10. Inside the container 10, since the connection space of the current collectors 31 and 41 can be omitted, the areas of the first electrodes 32 and the second electrodes 42 can be increased by the omitted space. In FIG. 1, the ends of each first electrode sheet 3 are located near the openings 12 and 13 of the container 10. The battery cell 1 can have a high energy density.

### Method for Manufacturing Battery Cell

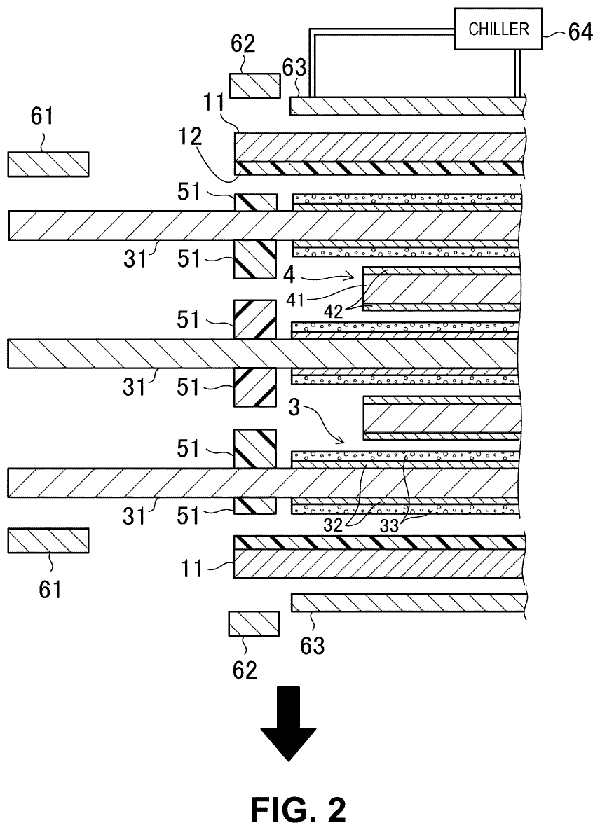

Next, a method for manufacturing the battery cell 1 will be described with reference to FIGS. 2, 3, 4, 5 and 6. The method for manufacturing the battery cell 1 proceeds in the order of FIGS. 2, 3, 4, 5 and 6. Here, the method for manufacturing the battery cell 1 will be described using the welding of the resin pieces at the first opening 12 as an example, but the same applies to the welding of the resin pieces at the second opening 13.

First, the first electrode sheets 3 and the second electrode sheets 4 are prepared. As described above, each first electrode sheet 3 has a current collector 31, first electrodes 32, and separators 33. The first electrode sheet 3 also has resin pieces 51 (see FIG. 2). Each resin piece 51 is located on the current collector 31 between the end of the current collector 31 and the first electrodes 32. Each resin piece 51 is welded in advance to a corresponding one of the first surfaces and second surfaces of the current collectors 31.

Each second electrode sheet 4 has a current collector 41, second electrodes 42, and resin pieces. Each resin piece of the second electrode sheet 4 is located on the current collector 41 between the end of the current collector 41 and the second electrodes 42, similarly to the resin piece 51 of the first electrode sheet 3. The resin pieces are welded in advance to a corresponding one of the first surfaces and second surfaces of the current collectors 41.

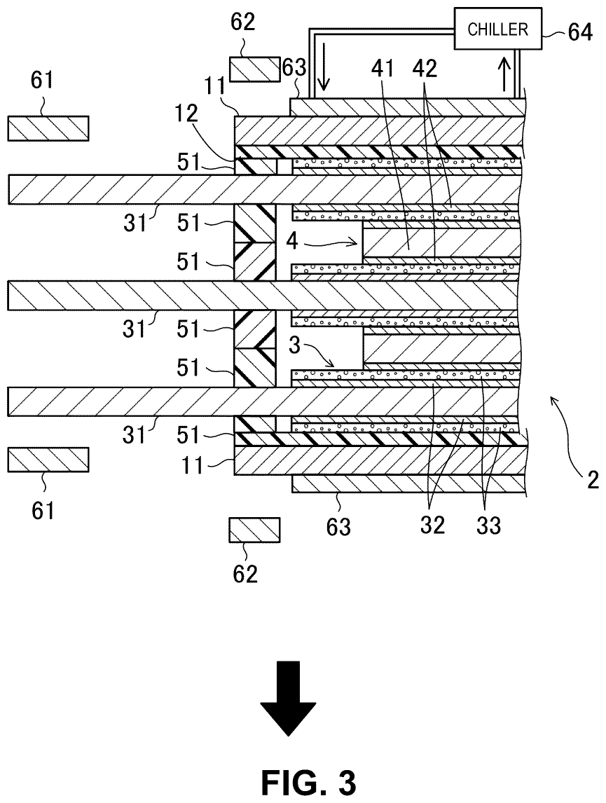

Next, the first electrode sheets 3 and the second electrode sheets 4 are layered alternately as shown in FIG. 2. As shown in FIG. 3, the first electrodes 32 and the second electrodes 42 are stacked with the separators 33 interposed therebetween. The resin pieces 51 are located between the current collectors 31 of the first electrode sheets 3. The resin pieces 51 are aligned in the layering direction. The resin pieces are also located between the current collectors 41 of the second electrode sheets 4.

Each resin piece 51 is a thermoplastic resin piece. The resin piece 51 is made of a material selected from cast polypropylene (CPP), low density polyethylene (LDPE), linear low density polyethylene (LLDPE), high density polyethylene (HDPE), oriented polypropylene (OPP), polyethylene terephthalate (PET), or oriented nylon (ONY).

After the first electrode sheets 3 and the second electrode sheets 4 are layered to form the electricity generation element 2, the laminate material 11 is placed on the electricity generation element 2. As shown in FIG. 3, the position of the edge of the laminate material 11 (the left edge in FIG. 3) corresponds to the position of the resin pieces 51. The laminate material 11 is located outside the outermost current collectors 31 in the layering direction. In other words, the laminate material 11 is located above the topmost current collector 31 and below the bottommost current collector 31 in the up-down direction in FIG. 3.

Next, cooling of the electricity generation element 2 is started. The electricity generation element 2 is cooled using heat sinks 63, 63. The heat sinks 63, 63 is in contact with the outer surface of the laminate material 11. The heat sinks 63, 63 are positioned at positions corresponding to the first electrodes 32 and separators 33 of the electricity generation element 2. The heat sinks 63, 63 are indirectly in contact with the electricity generation element 2 via the laminate material 11.

The length of the heat sinks 63, 63 in a direction perpendicular to the layering direction may be a length corresponding to the length of the first electrodes 32 and the separators 33. The length of the heat sinks 63, 63 may also be shorter than the length of the first electrodes 32 and the separators 33.

Each of the heat sinks 63, 63 is adjacent to at least the resin pieces 51. This is to promote the transfer of heat from the electricity generation element 2 adjacent to the resin pieces 51 to the heat sinks 63 when the resin pieces 51 are heated with first hot plates 61 or second hot plates 62 described later.

The heat sinks 63 are connected to the chiller 64. The heat medium circulates between the heat sinks 63 and the chiller 64 (see arrows in FIG. 3). The chiller 64 cools the heat sinks 63 via the heat medium. The chiller 64 is an example of a cooling device that cools the heat sinks 63. The cooling device is not limited to the chiller 64.

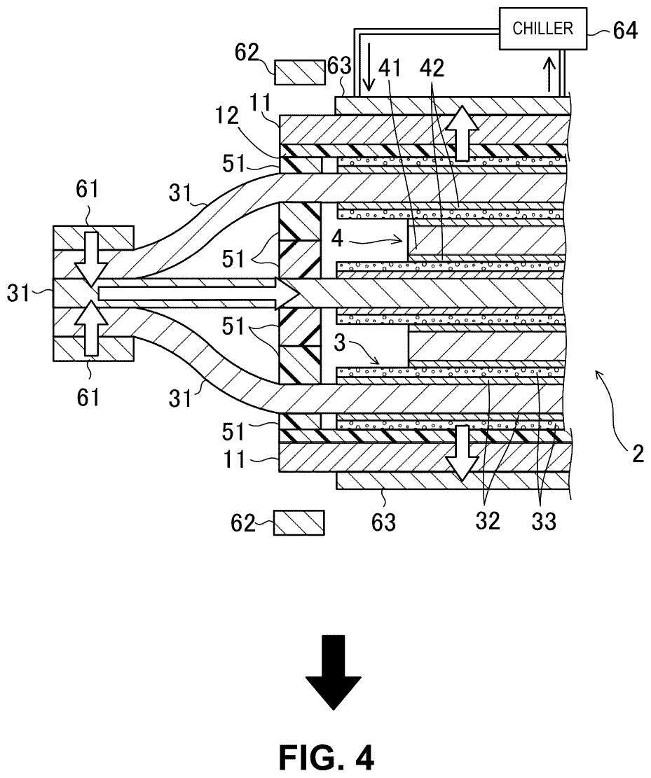

After cooling of the electricity generation element 2 is started, preheating of the resin pieces 51 is started as shown in FIG. 4. The resin pieces 51 are preheated using a pair of first hot plates 61, 61. Between the pair of first hot plates 61, 61 in the layering direction, the plurality of current collectors 31 are interposed at the end positions of the current collectors 31. The plurality of current collectors 31 are stacked in the layering direction. The high-temperature first hot plates 61, 61 heat the plurality of current collectors 31 in a state in which the current collectors 31 are stacked in the layering direction. As shown by white arrows in FIG. 4, heat energy is supplied from the pair of first hot plates 61, 61 through the current collectors 31 to the resin pieces 51. Note that in FIG. 4, an arrow is drawn only on the current collector 31 in the center of the layering direction, but heat energy is supplied to each of the resin pieces 51 in contact with the current collector 31 through the current collector 31. Each resin piece 51 is heated.

As the current collectors 31 are heated, heat is transferred to the first electrodes 32, the second electrodes 42, and the separators 33 of the electricity generation element 2. If the temperature of the separators 33 is too high, the separators 33 may undergo heat shrink.

In contrast, the heat sink 63 promotes the transfer of heat from the electricity generation element 2 to the heat sink 63, as shown by the white arrows in FIG. 4. The temperature rise of the separator 33 is prevented.

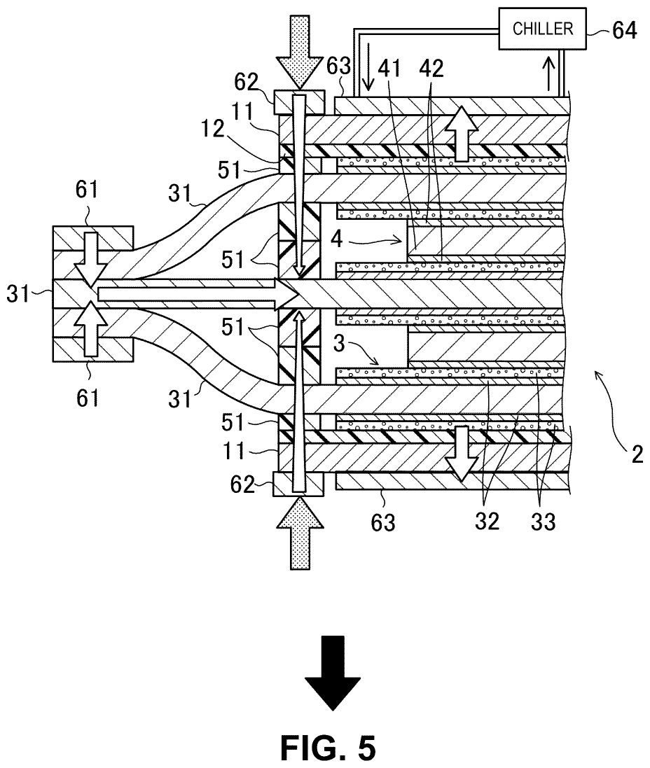

After the preheating of the resin pieces 51 is started, hot plate welding of the resin pieces 51 aligned in the layering direction is started as shown in FIG. 5. The hot plate welding is performed using a pair of second hot plates 62, 62. The pair of second hot plates 62, 62 are positioned on the outside of the laminate material 11, and pressurize the resin pieces 51 aligned in the layering direction from the outside to the center in the layering direction (see gray arrows in FIG. 4). At the same time, the pair of second hot plates 62, 62 heat the resin pieces 51 aligned in the layering direction. Preheating with the first hot plates 61, 61 continues also after hot plate welding with the second hot plates 62, 62 is started.

The heat energy from the high-temperature second hot plates 62, 62 is transmitted from the outside toward the center in the layering direction through the laminate material 11, resin pieces 51, and current collectors 31. The resin pieces 51 receive heat energy and melt.

Here, as shown by white arrows in FIG. 5, the heat energy supplied from the second hot plates 62, 62 to the resin pieces 51 located in the center in the layering direction is likely to be lower than the heat energy supplied to the resin pieces 51 located on the outside in the layering direction due to attenuation. The resin pieces 51 located in the center in the layering direction may not be sufficiently welded together.

In contrast, the resin pieces 51 located in the center in the layering direction is preheated through the current collectors 31. The resin pieces 51 located in the center in the layering direction are heated through the current collectors 31, and heat energy is also supplied from the second hot plates 62 in the layering direction. Sufficient heat energy is supplied to the resin pieces 51 located in the center in the layering direction.

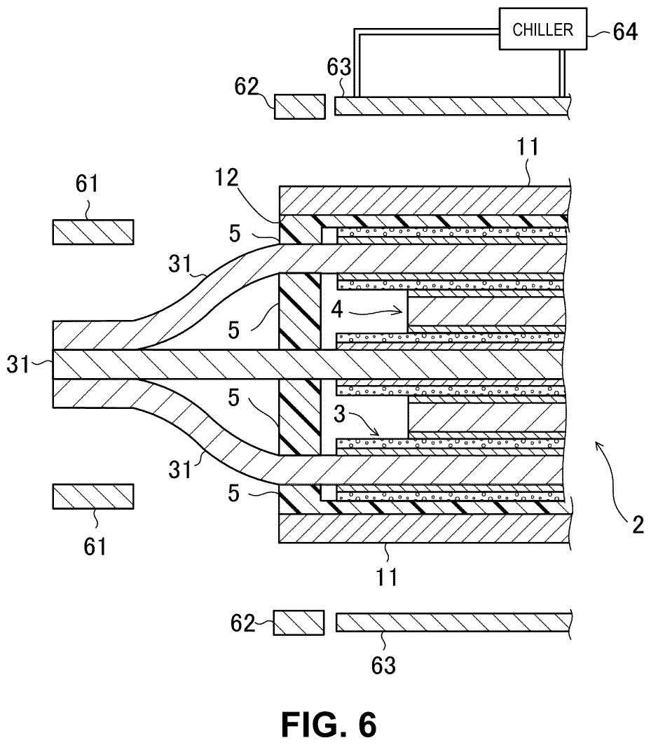

In this way, heat energy is sufficiently supplied to both the resin pieces 51 located on the outside in the layering direction and the resin pieces 51 located in the center in the layering direction. As shown in FIG. 6, at the opening (here, the first opening 12) of the container 10, the parts between the laminate material 11 and the current collectors 31, and the parts between the current collectors 31 are sealed with the welded resin pieces 5.

Here, while the hot plate welding of the resin pieces 51 is performed using the second hot plates 62, 62, the heat sink 63 promotes the transfer of heat from the electricity generation element 2 to the heat sink 63. Since the electricity generation element 2 expands close to the resin pieces 51, heat from the second hot plates 62, 62 is likely to be transferred to the separators 33 of the electricity generation element 2. The heat sink 63 prevents temperature rise of the separators 33 during hot plate welding. Heat shrink of the separators 33 is prevented.

As shown in FIG. 6, when welding of the resin pieces 51 is completed, the pressurization and heating with the second hot plates 62, 62 ends, and heating with the first hot plates 61, 61 also ends. If the first hot plates 61, 61 are separated from the current collectors 31, the current collectors 31 may be separated from each other in the layering direction.

After the heating with the first hot plates 61, 61 and the pressurization and heating with the second hot plates 62, 62 is completed, the heat sinks 63 continue to be in contact with the outer surface of the laminate material 11. The transfer of heat from the electricity generation element 2 to the heat sinks 63 continues. The temperature of the separators 33 drops quickly. The separators 33 are prevented from maintaining a high temperature state. Heat shrink of the separators 33 is prevented.

The heat sinks 63 separate from the outer surface of the laminate material 11, for example, after a predetermined time elapses after the completion of heating with the first hot plates 61, 61 and pressurization and heating with the second hot plates 62, 62.

As described above, during hot plate welding using the second hot plates 62, 62, the heat transfer from the electricity generation element 2 to the heat sinks 63 is promoted using the heat sinks 63. Since the temperature rise of the separators 33 of the electricity generation element 2 is prevented, the heat shrink of the separators 33 is prevented. In the manufactured battery cell 1, a short-circuit of the electrodes 32, 42 is prevented. The battery cell 1, in which the plurality of current collectors 31 are not connected inside the container 10 and the areas of the first electrode 32 and the second electrode 42 are accordingly increased, can be stably manufactured by the above-described manufacturing method.

In addition, in the manufacturing method described above, the resin pieces 51 are preheated using the first hot plates 61, 61 before hot plate welding is started using the second hot plates 62, 62. Heat energy is supplied sufficiently to both the resin pieces 51 located in the center in the layering direction and the resin pieces 51 located at the outside in the layering direction.

When the resin pieces 51 are preheated through the current collectors 31 prior to hot plate welding, it is possible to shorten the time from when pressurization and heating is started from the outside in the layering direction to when sufficient heat energy is supplied to the resin pieces 51 in the center in the layering direction. The resin pieces 51 on the outside in the layering direction can be prevented from being excessively supplied with heat energy.

As a result, the sealing strength of the openings 12 and 13 of the container 10 is prevented from varying from part to part. Since all of the resin pieces 51 can be stably welded together, the sealing quality of the openings 12 and 13 of the container 10 is improved.

Furthermore, since preheating through the current collectors 31 with the first hot plates 61, 61 continues after hot plate welding is started using the second hot plates 62, 62, heat dissipation through the current collectors 31 is prevented during hot plate welding with the second hot plates 62, 62. Since the resin pieces 51 are prevented from decrease in temperature due to heat dissipation, the resin pieces 51 can be sufficiently welded together.

The preheating through the current collectors 31 with the first hot plates 61, 61 ends when the hot plate welding using the second hot plates 62, 62 is completed. If preheating through the current collectors 31 is continued even after hot plate welding is completed, excessive heat energy may be supplied to the resin pieces 51. When the hot plate welding is completed, preheating through the current collectors 31 also ends, thereby preventing excessive supply of heat energy to the resin pieces 51.

Note that preheating through the current collectors 31 with the first hot plates 61, 61 may end before the completion of hot plate welding using the second hot plates 62, 62.

Preheating the resin pieces 51 through the current collectors 31 is advantageous for improving the sealing quality of the openings 12, 13 of the container 10. Contrarily, heat is transferred to the electricity generation element 2 through the current collectors 31, and this is therefore disadvantageous in terms of temperature rise of the separators 33. The use of the heat sinks 63 to promote the transfer of heat from the electricity generation element 2 to the heat sinks 63 prevents the temperature rise of the separators 33 even when the resin pieces 51 are preheated through the current collectors 31.

Cooling using the heat sinks 63 is started before preheating of the resin pieces 51 through the current collectors 31 is started. Even during preheating of the resin pieces 51, the temperature rise of the electricity generation element 2 is prevented, and once hot plate welding is started, the heat sinks 63 can quickly cool the electricity generation element 2. The temperature rise of the electricity generation element 2 is effectively prevented.

Furthermore, the heat sinks 63 is cooled using the chiller 64, further promoting the transfer of heat from the electricity generation element 2 to the heat sinks 63. The temperature rise of the electricity generation element 2 is more effectively prevented.

### Modifications

The temperature of the first hot plates 61 and the temperature of the second hot plates 62 may be the same or different. If the temperature and heating period of the first hot plates 61 and the temperature and heating period of the second hot plates 62 are individually set, each of the plurality of resin pieces 51 can be appropriately welded together. Individually controlling the preheating with the first hot plates 61 and the hot plate welding with the second hot plates 62 improves the sealing quality of the openings 12, 13 of the container 10.

In the method for manufacturing the battery cell 1 described above, the first hot plates 61, 61 heat the plurality of current collectors 31 in a state in which the current collectors 31 are stacked in the layering direction, but the first hot plates 61, 61 may selectively heat the current collector 31 located in the center in the layering direction.

In addition, in the above-described method for manufacturing the battery cell 1, preheating of the resin pieces 51 using the first hot plates 61, 61 can be omitted.

In addition, instead of hot plate welding using the second hot plates 62, the resin pieces 51 may be welded together by supplying energy to the resin pieces 51 from the outside toward the center in the layering direction by, for example, vibration welding, ultrasonic welding, or high-frequency welding. Even if there is attenuation of energy for welding in various welding techniques, it is possible to combine preheating of the resin pieces through the current collectors in the above-described manufacturing method, thereby sufficiently welding the resin pieces, located in the center in the layering direction, together.

The cooling device for the heat sinks 63 may be omitted. The heat sink may have, for example, heat dissipating fins. The heat sink having heat dissipating fins may be forcedly cooled using a fan, for example, or may be naturally cooled.

The technique disclosed herein does not exclude the omission of the heat sinks 63 in contact with the outer surface of the laminate material 11 in a structure that promotes the transfer of heat from the electricity generation element 2 to the outside of the electricity generation element 2.

What is claimed is:

1. A method for manufacturing a battery cell, the method comprising:
stacking electrode sheets in a layering direction to form an electricity generation element, the electrode sheets each including an electrode and a current collector, the electrodes being located in a container, the current collectors each being connected to the electrode in the container and protruding outward from an opening of the container;
pressurizing and heating resin pieces from an outside toward a center in the layering direction at a position of the opening of the container, the resin pieces being located between the adjacently stacked current collectors;
promoting transfer of heat from the electricity generation element to an outside of the electricity generation element during pressurizing and heating the resin pieces; and
welding the resin pieces together between the current collectors, and sealing the opening of the container.

2. The method for manufacturing the battery cell according to claim 1, wherein
each of the electrode sheets further includes a separator, the separator being in contact with the electrode on a side opposite the current collector, the separator separating the electrodes in the layering direction between the adjacently stacked electrode sheets.

3. The method for manufacturing the battery cell according to claim 1, wherein
the stacked resin pieces are interposed between a pair of hot plates in the layering direction, and thereby the resin pieces are pressurized and heated, the hot plates being positioned outside the container, and
while the resin pieces are pressurized and heated, a heat sink is brought into contact with an outer surface of the container at a position corresponding to the electrodes of the electricity generation element, and thereby promotes transfer of heat from the electricity generation element to the heat sink.

4. The method for manufacturing the battery cell according to claim 3, wherein
the heat sink is brought into contact with an outer surface of the container before the resin pieces are pressurized and heated.

5. The method for manufacturing the battery cell according to claim 3, wherein the heat sink is cooled by a cooling device.

6. The method for manufacturing the battery cell according to claim 4, wherein the heat sink is cooled by a cooling device.

7. The method for manufacturing the battery cell according to claim 1, wherein
before pressurization and heating of the resin pieces is started, preheating of the resin pieces through the current collectors is started.

8. The method for manufacturing the battery cell according to claim 7, wherein
preheating through the current collectors is continued also after start of pressurization and heating of the resin pieces.

9. The method for manufacturing the battery cell according to claim 1, wherein
after pressurization and heating of the resin pieces is completed, promotion of transfer of heat from the electricity generation element to an outside of the electricity generation element is continued.
